(19) United States
(12) Patent Application Publication
(10) Pub. No.: US 2024/0184523 A1
(43) Pub. Date: Jun. 6, 2024

(54) METHODS AND APPARATUS TO PERFORM MIXED RADIX FAST FOURIER TRANSFORM (FFT) CALCULATIONS ON GRAPHICS PROCESSING UNITS (GPUs)

(71) Applicant: Intel Corporation, Santa Clara, CA (US)

(72) Inventors: Bin Wang, Beijing (CN); Bo Peng, Beijing (CN); Xiaoyun Wang, Beijing (CN)

(21) Appl. No.: 18/553,185

(22) PCT Filed: Jun. 24, 2021
(86) PCT No.: PCT/CN2021/102020

§ 371 Date: Sep. 28, 2023

(51) Int. Cl. G06F 7/49

(52) U.S. Cl. CPC G06F 7/49

(57) ABSTRACT

Methods, apparatus, systems, and articles of manufacture are disclosed for mixed radix fast Fourier transform (FFT) calculations of graphics processing units (GPUs). An example apparatus disclosed herein includes at least one memory, machine readable instructions in the apparatus, and at least one processor circuitry to execute the machine readable instructions to at least factorize input data to identify one or more radix-r blocks for the parallel mixed radix calculation, perform at least one of a decimal-to-base or a base-to-base conversion of the input data prior to a bit reverse routine, the bit reverse routine to yield an output data set, cause a lookup table to be loaded into a memory structure based on a lookup table length, the lookup table populated with the output data set, and perform the parallel mixed radix calculation of the one or more radix-r blocks using the lookup table loaded into the memory structure.

### FIELD OF THE DISCLOSURE

This disclosure relates generally to computing systems, and, more particularly, to methods and apparatus to perform mixed radix fast Fourier transform (FFT) calculations on graphics processing units (GPUs).

### BACKGROUND

Fast Fourier transforms (FFTs) are efficient implementations of discrete Fourier transforms (DFTs) used in applications such as digital image processing. For example, an FFT can be applied to convert an image from the image (spatial) domain to a frequency domain, given that applying filters to images in the frequency domain is computationally faster as compared to applying such filters in the image domain. Image processing applications can rely on mixed radix FFTs to compute an FFT on any length of input data.

### BRIEF DESCRIPTION OF THE DRAWINGS

FIG. 1 illustrates an example calculation process using mixed radix fast Fourier transforms (FFTs).

FIG. 2 illustrates an example of bit reversal used as part of a factorization process associated with the mixed radix FFTs of FIG. 1.

FIG. 3A illustrates an example digit-based reversal for a first data length using a single decimal-to-base conversion.

FIG. 3B illustrates an example digit-based reversal for a second data length using a multiple base-to-base conversions.

FIG. 3C illustrates an example lookup table generated using the output of FIG. 3A.

FIG. 4 illustrates a relationship between a total number of identified factors and a performance ratio for registers, shared local memory, and/or dynamic random access memory (DRAM).

FIG. 5 illustrates an example multi radix FFT calculation using multiple execution unit(s) (EUs) of a graphics processing unit (GPU).

FIG. 6 illustrates an example multi radix FFT calculation using a single instruction, multiple data (SIMD) core.

FIG. 7 illustrates example FFT calculation times on different image sizes comparing processing using a central processing unit (CPU) versus a graphics processing unit (GPU).

FIG. 8 illustrates an example mixed radix FFT calculation process based on the operations of FIGS. 3A, 3B, 3C, 5, and/or 6 using a mixed radix FFT calculator.

FIG. 9 illustrates a block diagram of the mixed radix FFT calculator of FIG. 8 constructed in accordance with teachings of this disclosure.

FIG. 10 is a flowchart representative of example machine readable instructions that may be executed by example processor circuitry to implement the mixed radix FFT calculator of FIG. 9.

FIG. 11 is a block diagram of an example processing platform including processor circuitry structured to execute the example machine readable instructions of FIG. 3 to implement the mixed radix FFT calculator of FIG. 9.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIG. 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Methods and apparatus for mixed radix fast Fourier transforms (FFT) for applications in graphics processing units (GPUs) are disclosed herein. The Cooley-Tukey FFT algorithm can be used for computing a fast Fourier transform (FFT) based on a method proposed by J. W. Cooley and J. W. Tukey (e.g., Cooley-Tukey FFT algorithm). In general, the FFT algorithm computes a discrete Fourier transform (DFT) or an inverse discrete Fourier transform (IDFT) of a sequence. For example, a signal can be converted from an original domain (e.g., time, space) to a corresponding representation in the frequency domain. As such, FFT is widely used in signal processing applications. FFT-based computations can rely on a Fourier matrix to factorize the matrix into several sparse matrices, thereby reducing the total number of calculations required by eliminating redundant computations. For example, a large data set can be decomposed into smaller data sets (e.g., an FFT with a size of 64 can be decomposed into two data sets of 32, followed by four data sets of 16, eight data sets of 8, sixteen data sets of 4, and a total of thirty-two data sets of 2). The FFT can perform a DFT on the smaller data sets, with the results obtained from each of the transforms combined to obtain the final result. Using FFTs in software optimizes the software's performance by increasing the speed of algorithm execution. For example, FFTs provide algorithmic efficiency that is amplified as computer processors increase their speed of execution. The FFT algorithm can be used to divide input samples into a number of one-sample long signals, followed by a re-ordering of the samples (e.g., using a bit-reversed order). In image processing applications, the Fourier transform can be used to decompose an image into real and imaginary components which are representative of the image in the frequency domain. Likewise, the number of frequencies in the frequency domain can be equal to the number of pixels of an input image or spatial domain. An inverse transform re-transforms the frequencies to the image in the spatial domain using FFT and its inverse of the image (e.g., a 2D image).

The mixed radix FFT is a general Cooley-Tukey FFT algorithm widely used in digital recording, sampling, additive synthesis and pitch correction software. Mixed radix FFTs can use the Cooley-Tukey algorithm to compute in-place complex FFTs for length which are a power of two (e.g., radix-2 algorithms). However, mixed radix functions can be used for FFTs of any length using sub-transform modules (e.g., optimized small length FFTs combined to create larger FFTs). For example, such sub-transform modules can be efficient for factors of 2, 3, 4, 5, 6, and 7 (e.g., modules for composite factors of 4 and 6 are faster than combining modules for 2×2 and 2×3). In some examples, storage arrangements can be different for radix-2 versus mixed-radix routines. In radix-2 routines, locations where each element can be stored can be constrained (e.g., real and imaginary parts can be stored separately). In contrast, mixed radix algorithms are desirable for improved locality of memory access given their ability to store real and imaginary parts of a given term. Additionally, the mixed radix FFT can be used for arbitrary length data series and relies on a strict calculation order. For example, to perform bit-reversal operations using FFT, current methods using mixed radix FFTs rely on first loading input data, followed by reversed indexing according to an input index, and arrangement of the data into new index positions. In computing systems, arbitrary length-based FFT algorithms and bit reversals can be performed on the central processing unit (CPU) in sequential steps. However, repetitive steps associated with the arbitrary length-based FFT algorithms and bit reversals on CPUs are time consuming, inhibiting the full potential performance of such algorithms on the CPU. Likewise, existing methods of using arbitrary length-based FFT algorithms and bit reversals may not be suitable for implementation in graphics processing units (GPUs). For example, such algorithms and bit reversals may not take full advantage of the computing power and memory available via the GPU core.

Methods and apparatus for mixed radix fast Fourier transforms (FFT) for applications in graphics processing units (GPUs) are disclosed herein. In the examples disclosed herein, a parallel method of general mixed radix FFTs is implemented for calculating FFTs of real and/or complex data sets of any length. For example, multiple points can be computed in parallel on the GPUs instead of computing mixed radix FFTs point-by-point on the CPU. Additionally, methods and apparatus disclosed herein introduce calculation patterns based on FFT length for bit-reversed orders (e.g., used for radix-2 FFT algorithms). As such, methods and apparatus disclosed herein significantly improve processing performance by using multiple execution units (EUs) and/or single instruction, multiple data (SIMD) features available on graphics processing units (GPUs). For example, GPUs are made of massively parallel, smaller, and more specialized cores compared to those found in high-performance CPUs given that GPU architecture is optimized for aggregate throughput across all crores, thereby deemphasizing individual thread latency and performance.

Additionally, GPU architecture can efficiently process vector data with more silicon space dedicated to compute and less dedicated to cache and control. In GPUs, multiple SIMD instruction streams can be mapped to a single execution unit (EU), such that the GPU EU can context switch among SIMD instruction streams when one stream is stalled. Multiple EUs combine to form a compute unit with shared local memory and synchronization mechanisms, with the compute units combined to form the GPU. As such, GPUs can include thousands of small and efficient SIMD cores/EUs, allowing for efficient execution of data-parallel code and high dynamic random-access memory (DRAM) bandwidth. Given that current methods have not taken full advantage of the processing power available via the GPU, methods and apparatus disclosed herein reduce repetitive calculations by implementing mixed radix FFTs on GPUs. For example, using methods and apparatus disclosed herein, calculations associated with DFTs can be performed in parallel using GPU-based EUs and SIMDs. Use of GPUs can provide a performance increase of up to 20-25 times of the typical performance speed (e.g., associated with performing calculations on CPUs), while bit-reversals efficiency can be improved by up to 4.4 times when taking advantage of the memory hierarchy available on GPUs. In the examples disclosed herein, GPUs can be used to accelerate the mixed radix FFT algorithm calculation using thread level parallelism (TLP) and/or data level parallelism (DLP).

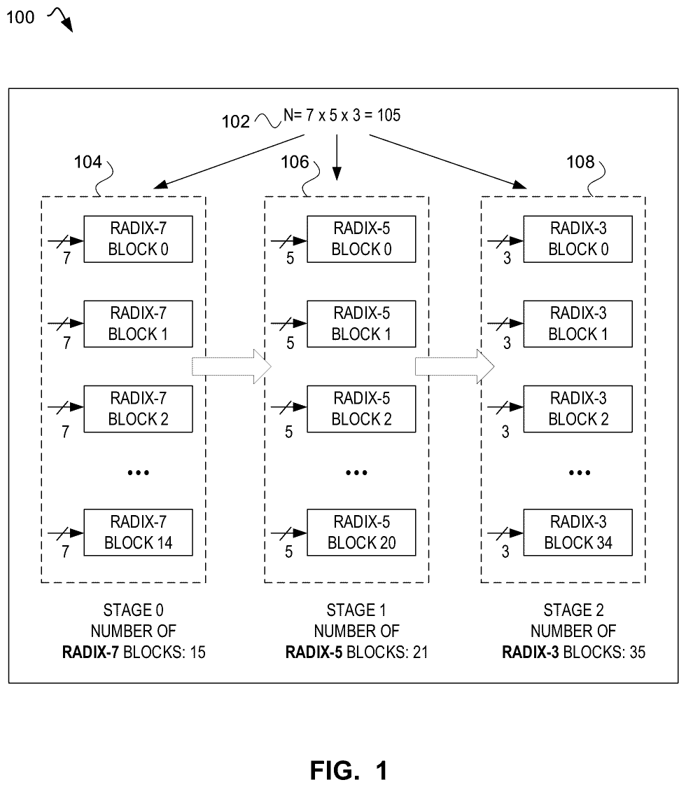

FIG. 1 illustrates an example calculation process 100 using example mixed radix fast Fourier transforms (FFTs). Using mixed radix FFT algorithms allows data length N to be factorized into any general factor (e.g., N=r₁*r₂*r₃* . . . , where r₁, r₂ are prime numbers). The discrete Fourier transform (DFT) of length N can be recursively broken down into smaller DFTs of sizes r₁, r₂, r₃ called radix-r₁, radix-r₂, radix-r₃, etc. In the example of FIG. 1, a mixed radix FFT is calculated on a data series of length 105 (N=105) using an example N factorization 102. The data length N is factorized into three factors (e.g., r₁=7, r₂=5, and r₃=3). The three factors correspond to three separate example stages 104, 106, 108 (e.g., stage 0, stage 1, and stage 3). In each one of the stage(s) 104, 106, 108, the DFT of length 105 is broken down into multiple smaller DFTs called radix-r blocks. In the example of FIG. 1, a total of 15 radix-7 blocks are generated (e.g., 105/7=15 blocks) in stage 0, a total of 21 radix-5 blocks are generated (e.g., 105/5=21 blocks) in stage 1, and a total of 35 radix-3 blocks are generated (e.g., 105/3=35) in stage 2. As such, an efficient implementation for the DFT is possible using mixed radix FFT calculations.

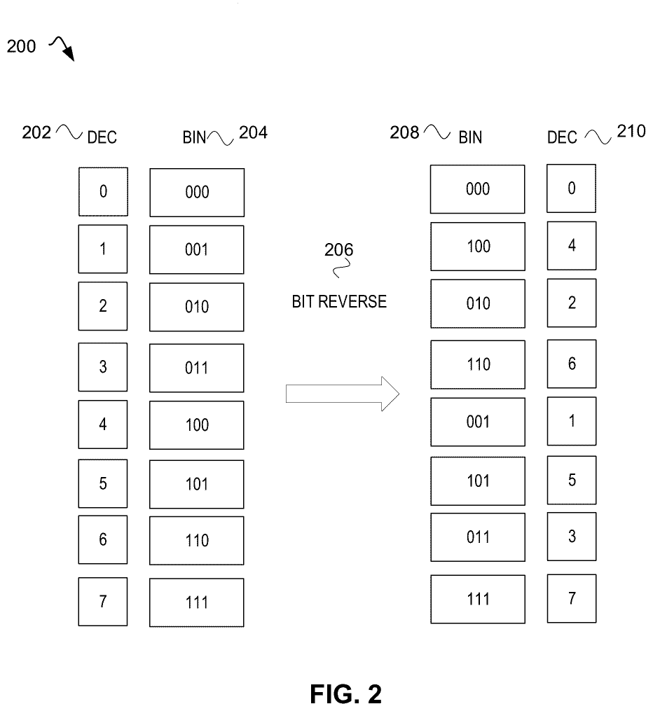

FIG. 2 illustrates an example bit reversal 200 used as part of a factorization process associated with the mixed radix FFTs of FIG. 1. For example, input data series are reordered before the start of the first stage 104 shown in FIG. 1. Bit reversal reverses binary bits of an input index to obtain a new index, with each fixed integer value having a corresponding unique reversed value. Binary numbers are expressed in the binary numeral system (e.g., base-2) which represents numeric values using two different symbols (e.g., zeros and ones), with each digit referred to as a bit. In the example of FIG. 2, each of the index values 1-7 (e.g., input decimals 202) include an example corresponding binary number 204 (e.g., 1=001, 2=010, 3=011, etc.). Reversing the binary numbers 204 associated with the input decimals 202 using an example bit reverse order 206 produces example output binary numbers 208. The output binary numbers 208 are used to generate example output decimals 210 (e.g., 100=4, 010=2, 110=6, etc.). Data ordering required by radix-2 FFTs is in bit reversed order, such that bit-reversed indices are used to combine FFT stages. While it is possible to calculate these bit-reversed indices in software, bit reversals become trivial when implemented in hardware (e.g., a digital signal processor (DSP) includes a hardware bit-reversal indexing capability). In addition to bit reversal, digit reverse routines can also be used to reorder data based on its index value from 0 to N−1, where N is the number of points to be bit and/or digit-reversed. Discrete transforms using bit reverse and/or digit reverse routines can be executed in place using the same memory locations for both inputs and outputs, thereby reducing data size and/or algorithmic complexity. These routines are needed to take full advantage of in-place execution. For example, as shown in FIG. 2, while the input is in normal order, the output is in bit-reverse order. Thereby, to view the resulting output in normal order, the results are bit reversed.

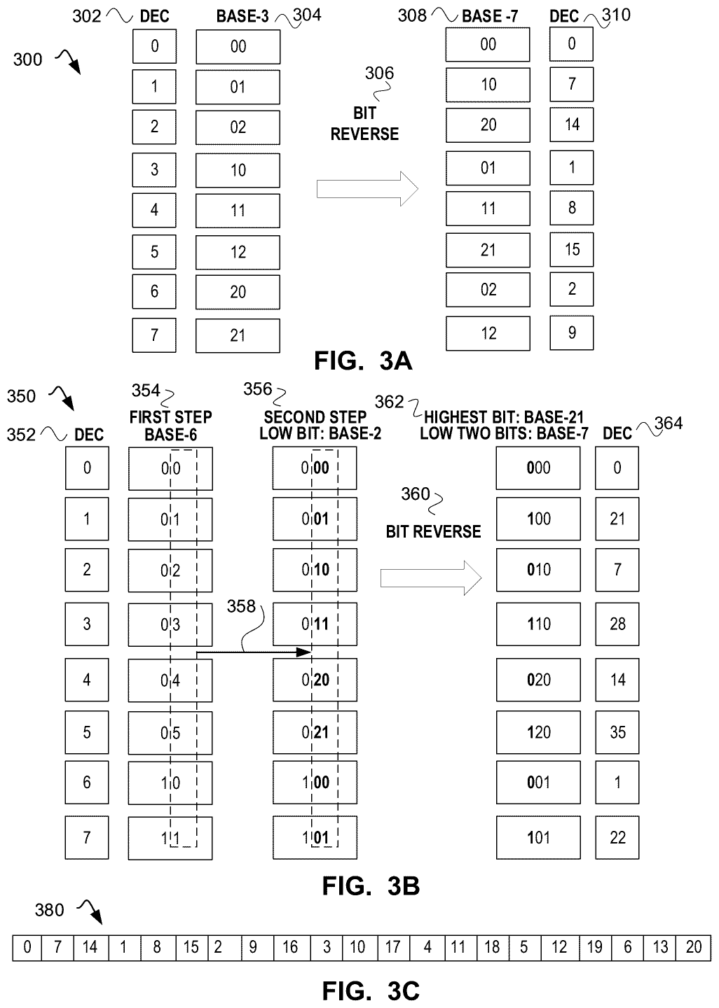

FIG. 3A illustrates an example digit reverse routine 300 for a specified data length. The digit reverse routine 300 is similar to bit reversal 200 shown in FIG. 2, except that the digit reversal routine 300 reverses digits instead of bits. For example, digit reversal can be used to convert decimals to a bit series, reverse the resulting bit series, and convert the bit series back to decimals. Rules governing conversions from decimals to bit series and/or from bit series to decimals is associated with data length and factorization. In the example of FIG. 3A, the length of the data to be reordered is fixed and the factorized factors are also fixed, with each fixed integer value still having a corresponding unique reversed value. Furthermore, FIG. 3A shows digit reversal using bases other than base-2 (binary), which relies on only two digits (e.g., 0 and 1). For example, other bases can be used as well, such as ternary (base-3), which consists of three digits (e.g., 0, 1, and 2), quaternary (base-4), which consists of four digits (e.g., 0, 1, 2, and 3), and so on. In the example of FIG. 3A, bit reversal is performed using base-3 (e.g., using digits 0, 1, 2), based on a data length of 21 (e.g., N=21, where 3×7=21), such that the input is in base-3 initially and is converted to base-7 after bit reversal to obtain the output decimal numbers. An example input decimal set 302 is converted to an example base-3 set 304, followed by an example bit reversal routine 306 to yield an example base-7 output 308. The resulting base-7 output 308 is converted to an example output decimal set 310. This allows FFT-based calculations to be performed using mixed radix-3 and mixed radix-7 to obtain the encoded and decoded data, where base-3 is used to convert to a data input and base-7 is used to convert to an output.

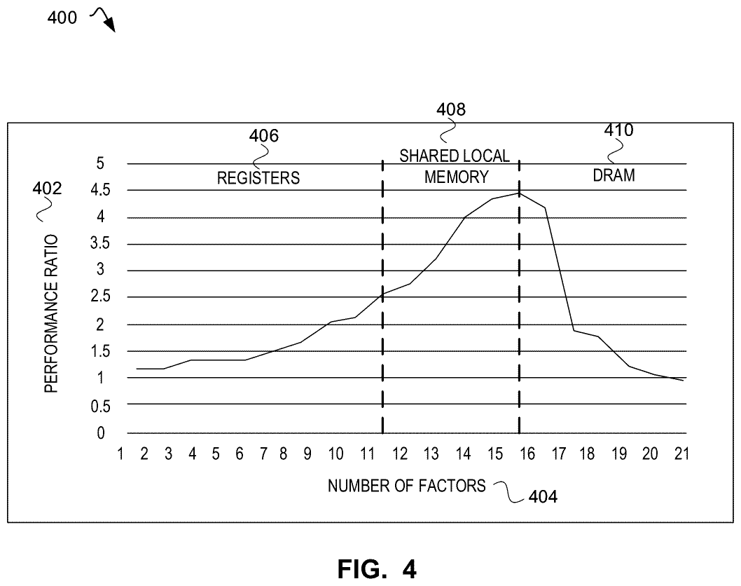

Conversely, the calculation can be performed using a data length of 42 (e.g., N=42, where 2×3×7=42), as shown in an example bit reverse routine 350 of FIG. 3B. Decimals 0-7 (e.g., decimals 352) are converted to bits using base-6 (e.g., based on digits 0, 1, 2, 3, 4, 5) to yield an example base-6 input set 354 using a first conversion process. The resulting bits (e.g., 00, 01, 02, 03, etc.) undergo a second conversion process where example low bits 358 of the base-6 results (e.g., 0, 1, 2, 3, 4, etc.) are converted to an example base-2 set 356, while the high bits are retained (e.g., yielding an input of 000, 001, 010, 011, 020, etc.). Once the second conversion process is complete, the input values are bit reversed using an example bit reverse routine 360 (e.g., such that 000, 001, 010 are bit reversed to 000, 100, 010) to yield an example bit-reversed set 362. The output of the bits is determined by performing a third conversion process, in which the highest bit (e.g., 0, 1, 0, 1, etc.) of the output is converted using base-21 and the lowest two bits of the output (e.g., 00, 00, 10, 10, 20, 20, etc.) is converted using base-7, thereby obtaining example final decimal-based outputs 364 (e.g., 0, 21, 7, 28, etc.). While in the example of FIG. 3A a total of two mixed radices are used to determine the output for a data length of 21, FIG. 3B uses a total of three mixed radices to determine the output for a data length of 42. The data length corresponds to a number of factors (n), such that data length is equivalent to the number of factors raised to the power of two (e.g., n²). Used the results of FIG. 3B, a lookup table shown in the example of FIG. 3C can be generated (e.g., using a central processing unit (CPU)) based on the input data lengths (e.g., N=21, N=42, etc.) and the corresponding number of factorized factors (e.g., 4-5 factors for N=21, 6-7 factors for N=42, etc.). In the example of FIG. 3C, an example lookup table 380 is generated based on the data of FIG. 3A. The lookup table 380 corresponds to data length N=21 based on the outputs generated using the digital reverse process (e.g., output decimal set 310). Methods and apparatus disclosed herein improve performance efficiency (e.g., using GPUs) based on calculation patterns determined using FFT length, as shown in the example of FIGS. 3A-3B. For example, the lookup table 380 of FIG. 3C can be generated on CPU-based memory and moved to GPU-based memory to optimize data reordering on the GPU, as described in connection with FIG. 4.

FIG. 4 illustrates an example graph 400 showing a relationship between an example performance ratio 402 and an example total number of identified factors 404 for example registers 406, example shared local memory 408, and/or example dynamic random access memory (DRAM) 410 on a GPU. In some examples, the lookup table 380 of FIG. 3C can be sent to a specific GPU memory structure based on the lookup table length and memory level hierarchy of the GPU to achieve maximized GPU performance. For example, while DRAM 410 has the largest memory capacity, processing delays can occur. Likewise, shared local memory (SLM) 408 supports programmer managed data for sharing GPU-based execution unit (EU) hardware threads (e.g., with a size of 64K bytes), causing the SLM 408 processing delay to be greater than that of registers 406 but reduced compared to the DRAM 410. GPU-based registers can be private to each EU, providing the fastest access speeds and highest bandwidths, but the register 406 also has the smallest capacity (e.g., 4K bytes). As such, making use of the optimal GPU memory type can depend on the final length of the lookup table 380 generated in the example of FIG. 3C. Methods and apparatus disclosed herein determine which GPU memory type is optimal for lookup table 380 storage based on lookup table 380 length. For example, when the lookup table 380 length is less than 1024, the table 380 can be stored in registers 406 as an unsigned short type (e.g., 2K bytes are used to store the lookup table 380, while other 2K bytes are used for other FFT stages). When the lookup table 380 length is determined to be greater than 1024 (2K bytes) but less than 32768 (64K bytes), the table 380 can be stored in shared local memory 408 as an unsigned short type. Likewise, when the lookup table 380 length is greater than 32768, the table 380 can be stored in DRAM 410 as an unsigned int type. As the lookup table 380 length continues to increase, lookup table 380 read operations will become slower than directly calculating bit/digit reverse at runtime. As such, a threshold can be set for the lookup table 380 length (e.g., a maximum length of 2¹⁹) to switch between direct calculation of bit/digit reverse at runtime and storage in a designated GPU memory structure.

As described in connection with FIGS. 3A-3C, the performance of calculating bit/number reverse at runtime is related to the number of factors (e.g., prime numbers) used in factorization. To test the relationship between processor performance and the number of factors, data can be reordered using two different methods: (1) using direct calculations of bit/digit reverse at runtime and/or (2) using lookup tables as shown in the example of FIG. 3C, with both methods performed on the GPU. For example, the prime number 2 can be used as a factor to test the processor performance, with the number of factors (n) changing from 1 to 21 (e.g., data lengths ranging from 2¹ to 2²¹). As shown in the example of FIG. 4, a performance ratio 402 can be determined for each GPU memory type based on a comparison of using a bit/digit reverse at runtime method to a lookup table method (e.g., a ratio of processor performance when using FFT-based calculations obtained using bit/digit reverse at runtime to processor performance when using FFT-based calculations obtained using lookup tables). In the example of FIG. 4, when the number of factors 404 is less than 10, the lookup table 380 can be loaded from registers 406. Given that the data length is minimal, an improvement in performance is noted on a level of approximately 1.2-2.5 times. When the number of factors 404 increases to a range of 10-15, the lookup table 380 can be loaded from shared local memory 408 instead of being loaded from the registers 406. The performance ratio 402 increases significantly, reaching a maximum value (e.g., up to 4.4 times increased performance) when the number of factors 404 used is 15 (e.g., corresponding to a data length of 32768), the size of the lookup table 380 reaching up to 64K bytes. As the number of factors 404 increases to more than 15, the lookup table 380 can be loaded from the DRAM 410, with the performance ratio 402 decreasing due to the DRAM 410 access speed also decreasing (e.g., compared to the shared local memory 408, etc.). Once the number of factors 404 increases to more than 19 factors, using the lookup table methodology becomes slower than directly calculating bit/digit reverse, thereby causing the calculation process to switch to directly calculating on the GPU at runtime.

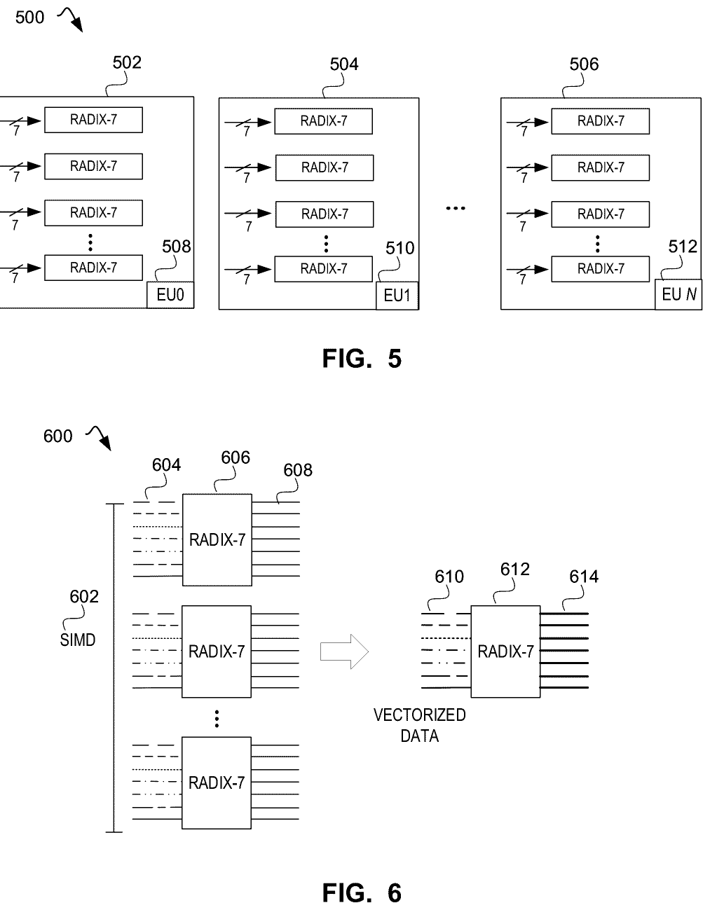

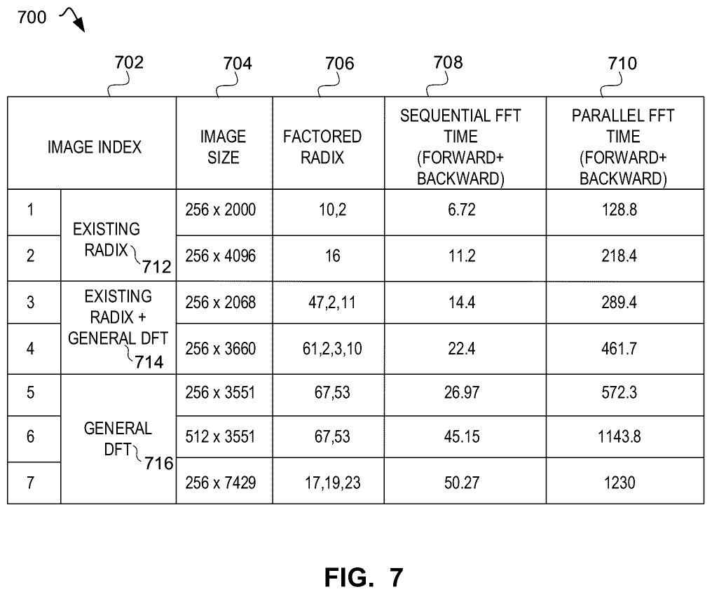

FIG. 5 illustrates an example multi radix FFT calculation 500 using multiple execution unit(s) (EUs) of a graphics processing unit (GPU). After reordering data, the FFT can be calculated in place. For example, each stage of the FFT calculation 500 can proceed sequentially. In the examples disclosed herein, radix-r blocks 502, 504, 506 can be calculated in parallel. For example, multiple execution unit(s) 508, 510, 512 (e.g., EU0, EU1 . . . EUN) can be used to perform calculation processes associated with multi radix FFT calculations (e.g., radix-7 calculations). In the example of FIG. 5, radix-7 blocks are calculated in multi cores of a GPU for each stage of the calculation process. Similarly, FIG. 6 illustrates an example multi radix FFT calculation 600 using an example single instruction, multiple data (SIMD) core 602. In the example of FIG. 6, multi radix-7 blocks 606 are calculated in parallel using SIMD-based instructions for each of the cores associated with FIG. 5 (e.g., EUs 508, 510, 512). For example, inputs 604 are provided to each of the individual radix-7 blocks 606, with corresponding outputs 608 generated based on the calculations described in connection with FIGS. 3A, 3B. As such, parallel calculations are used to generate example vectorized input data 610 into an example radix-7 block 612, resulting in an example output 614. All calculation stages can be completed in parallel as shown in the examples of FIGS. 6-7, with the output series available once the FFT-based calculations have been performed.

FIG. 7 illustrates example FFT calculation data 700 on different image sizes comparing processing using a central processing unit (CPU) versus a graphics processing unit (GPU). In some examples, up to 15 different radix-r blocks can be used as part of the FFT-based algorithm calculations disclosed herein (e.g., where r is between 2 and 16). To support arbitrary length data series used in the calculations associated with FIG. 4, a general DFT of length r can be implemented, as shown in the example of Equation 1:

$$\begin{matrix}X ( k ) = {\sum }_{n = 0}^{N - 1} x ( n ) \cdot {e}^{\frac{- i \cdot 2 π \cdot n \cdot k}{N}} & k = 0 , 1 , … , N - 1\end{matrix} \qquad ( 1 )$$

FIG. 7 includes an example input image index 702, an example input image size 704, an example factorized radix 706, an example calculated sequential FFT time 708, and an example calculated parallel FFT time 710. As such, FIG. 7 presents data associated with algorithm-based testing including a comparison of (1) example existing radix-based calculations 712. (2) example existing radix-based calculations combined with general DFTs 714, and (3) example general DFTs only 716. In the example of FIG. 7, existing radix 712 represents the 15 radix blocks that can be used as part of the FFT-based algorithm calculations disclosed herein (e.g., where r is between 2 and 16). In the example of FIG. 7, multiple input image sizes 704 (e.g., 256×2000, 256×4096, 512×3551, etc.) are used for testing on a CPU versus a GPU, including varying factored radices 708 (e.g., 10, 2 versus 16 versus 47, 2, 11, etc.). As mixed radix FFT calculations are performed on input images, each column of data reflects the separate testing of 1D FFTs. In the example of FIG. 7, sequential FFT calculation time (milliseconds) 708 (e.g., obtained using a CPU) is compared to parallel FFT calculation time (milliseconds) 710 (e.g., obtained using a GPU based on the use of EUs and SIMDs in parallel) for each of the calculation methodologies 712, 714, 716. Based on the results of FIG. 7, the disclosed parallel FFT calculations 710 using the GPU achieve increased efficiency, with a performance improvement of up to 20-25 times when compared to using the CPU only (e.g., sequential FFT time 708). In the examples of FIG. 7, the tested algorithms are implemented using a development package (e.g., Intel® C for Metal development package for Intel® graphics technology), with an APL experimental environment platform (e.g., Intel E3940 @1.6 GHz using Intel HD Graphics 505, 8GB DDR3, Ubuntu 16.04 LTS).

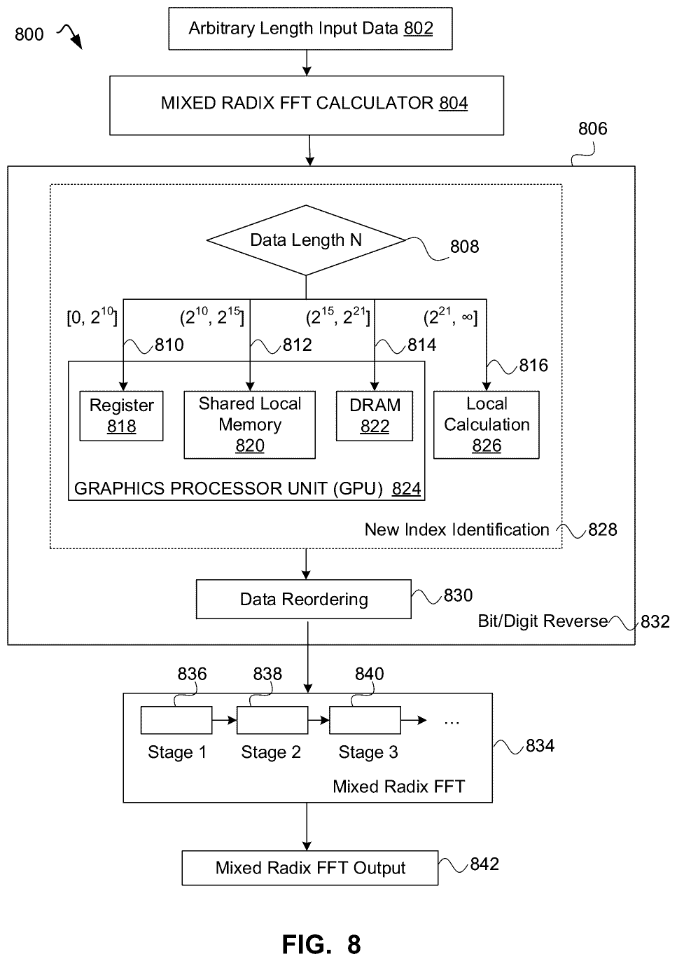

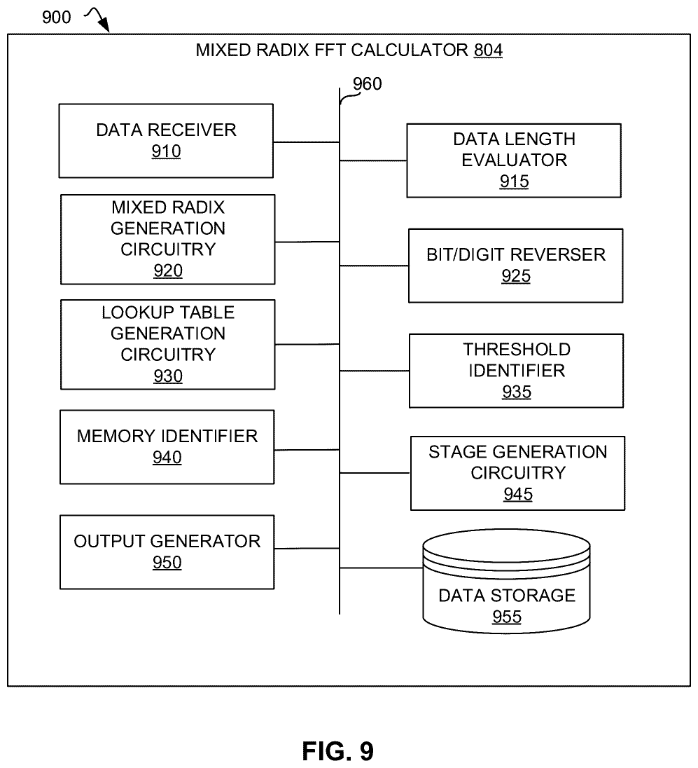

FIG. 8 illustrates an example multi radix FFT calculation process 800 implemented using a GPU as shown in FIGS. 3A, 3B, 3C, 5, and/or 6. In the example of FIG. 8, an arbitrary length input data 802 is provided to a mixed radix FFT calculator 804 for processing. In some examples, the input data 802 can include data corresponding to an image file. The mixed radix FFT calculator 804 performs the FFT-based calculations described in connection with FIGS. 3A, 3B, 3C, 5, and/or 6, as further detailed in FIG. 9. For example, the mixed radix FFT calculator 804 performs example operations 806 associated with input data length identification 808 and/or output data length(s) 810, 812, 814, 816 classifications. In the example of FIG. 8, the mixed radix FFT calculator 804 uses generated lookup table(s) (e.g., lookup table 380) to identify whether the output data length(s) 810, 812, 814, 816 permit the storage of the lookup table(s) in a register 818, shared local memory 820, and/or DRAM 822 of an example graphics processor unit (GPU) 824. In some examples, the mixed radix FFT calculator 804 determines that the output data length 816 meets a specified data length threshold (e.g., a maximum length of 2¹⁹) such that local calculation 826 is performed without storing the lookup tables in GPU 824 memory. Additional indices can be generated during the FFT calculation process 800 using example new index identification 828. For example, the mixed radix FFT calculator 804 can identify new indices during bit/digit reversal routines and/or as new mixed radices are generated to process incoming data. In some examples, the mixed radix FFT calculator 804 performs data reordering 830 using an example bit/digit reverse routine 832. Once data reordering 830 is complete, the mixed radix FFT calculator 804 can initiate an example mixed radix FFT parallel calculation 834 using multiple stages (e.g., examples stages 836, 838, 840) corresponding to a total number of factors used to factorize a given data length, as described in connection with FIG. 5, to yield an example mixed radix FFT output 842.

FIG. 9 illustrates a block diagram 900 of the mixed radix FFT calculator 804 of FIG. 8 constructed in accordance with teachings of this disclosure. The mixed radix FFT calculator 804 includes an example data receiver 910, an example data length evaluator 915, an example mixed radix generator circuitry 920, an example bit/digit reverser 925, an example lookup table generation circuitry lookup table generation circuitry 930, an example threshold identifier 935, an example memory identifier 940, an example stage generation circuitry 945, an example output generator 950, and an example data storage 955. In the example of FIG. 9, the data receiver 910, the data length evaluator 915, the mixed radix generator circuitry 920, the bit/digit reverser 925, the lookup table generation circuitry 930, the threshold identifier 935, the memory identifier 940, the stage generation circuitry 945, the output generator 950, and/or the data storage 955 are communicably coupled using an example bus 960.

The data receiver 910 receives input data (e.g., arbitrary length input data 802 of FIG. 8). In some examples, the data receiver 910 receives data in the form of an input image with a designated image index and/or image size, as shown in connection with FIG. 7. However, the data receiver 910 can receive any type of input data and/or input data of any length. In some examples, the type of data input and/or length of data input can determine the mixed radix FFT calculation steps (e.g., number of mixed radices, types of radices used, etc.).

The data length evaluator 915 identifies the length of input data received by the data receiver 910. In some examples, the data length evaluator 915 determines the length of data once a decimal-to-bit, bit-to-bit, and/or a bit-to-decimal conversion is complete. For example, the data length evaluator 915 identifies the length of input and/or output data after bit reversal routines are complete (e.g., bit reversals 206, 306, 360 of FIGS. 2, 3A, 3B). For example, the data length evaluator 915 can be used to identify the length of data in a lookup table generated using the output results (e.g., lookup table 380 of FIG. 3C).

The mixed radix generator circuitry 920 generates one or more radices (e.g., radix-2, radix-3, radix-4, etc.) based on factorization of a given data length received from input data (e.g., input data 802). For example, a data length of N=105 (7×5×3=105) can be used to generate parallel-based calculations of mixed radices using radix-7 blocks, radix-5 blocks, and/or radix-3 blocks, as shown in connection with FIG. 1. The mixed radix generator circuitry 920 can generate any number of radices depending on the input data length and/or number of factors. For example, the mixed radix generator circuitry 920 generates radix-r blocks for each stage of a mixed radix FFT calculation performed on GPU execution unit(s) and/or a single instruction, multiple data (SIMD) core. For example, a total of 15 radix-7 blocks can be generated (e.g., 105/7=15 blocks) in a first stage, a total of 21 radix-5 blocks can be generated (e.g., 105/5=21 blocks) in a second stage, and a total of 35 radix-3 blocks can be generated in a third stage of the mixed radix calculation process performed on the GPU.

The bit/digit reverser 925 performs bit reverse and/or digit reverse. For example, once a decimal-to-bit conversion is complete, the bit/digit reverser 925 reverses a given set of bits. In some examples, the bit/digit reverser 925 can be used to obtain an output set of index values based on an input set of index values. For example, the bit/digit reverser 925 can reverse bits once a decimal-to-bit conversion is complete and/or once a bit-to-bit conversion is complete. In some examples, the bit/digit reverser 925 can be used to obtain an output set of index values based on the reversed bits (e.g., as a result of converting from bits to decimals).

The lookup table generation circuitry 930 generates a lookup table based on the output set of index values obtained using the bit/digit reverser 925. In some examples, the lookup table generation circuitry 930 performs the lookup table generation on a central processing unit (CPU). For example, the lookup table can be generated on CPU-based memory and moved to GPU-based memory to optimize data reordering on the GPU. In some examples, the lookup table generation circuitry 930 generates a lookup table to determine which GPU memory structure (e.g., a register, etc.) can be used for loading the lookup table into memory.

The threshold identifier 935 identifies a threshold associated with maximum lookup table length. For example, the threshold identifier 935 assigns a maximum length of the lookup table that can be used for loading the lookup table into GPU memory (e.g., a maximum length of 2¹⁹). In some examples, the threshold identifier 935 sets a threshold that can be used to determine whether mixed radix FFT-based calculations (e.g., bit/digit reverse) can be performed at runtime (e.g., using the local calculation 826 of FIG. 8) and/or whether efficiency would be improved by storing the lookup table in one or more designated GPU memory structures (e.g., registers, shared local memory, DRAM, etc.).

The memory identifier 940 identifies storage space on a designated GPU memory structure (e.g., registers, shared local memory, DRAM, etc.). In some examples, the memory identifier 940 determines which GPU-based memory structure can be used to store a given lookup table (e.g., based on lookup table length). In some examples, the memory identifier 940 can be used to retrieve lookup table information from the GPU-based memory structure during mixed radix FFT calculations on the GPU.

The stage generation circuitry 945 generates one or more stages for performing mixed radix FFT calculations on a GPU (e.g., the GPU 824 of FIG. 8). For example, the stage generation circuitry 945 generates a total number of stages based on the number of factors used to factorize a data series of a given length. For example, is a mixed radix FFT is calculated on a data series of length 105 (N=105) using an example N factorization 102, the data length N can be factorized into three factors (e.g., r₁=7, r₂=5, and r₃=3). The three factors correspond to three separate example stages (e.g., stage 0, stage 1, and stage 3), such that each stage of the FFT calculation can proceed sequentially. In some examples, radix-r blocks are calculated in multi cores of a GPU for each stage of a mixed radix FFT calculation.

The output generator 950 generates a mixed radix FFT calculation output (e.g., output 842 of FIG. 8). In some examples, the output generator 950 generates the calculation output once all stages of the FFT calculation are complete (e.g., stages 836, 838, 840 of FIG. 8). In some examples, the output generator 950 provides an output (e.g., output 614 of FIG. 6) based on one or more input(s) of vectorized data (e.g., vectorized data 610) received by a radix-r block (e.g., radix-7 block 612). In some examples, the output generator 950 generates an output of the mixed radix FFT calculations to complete the processing of the original input data (e.g., input image data) received by the data receiver 910.

The data storage 955 can be used to store any information associated with the data receiver 910, the data length evaluator 915, the mixed radix generator circuitry 920, the bit/digit reverser 925, the lookup table generation circuitry 930, the threshold identifier 935, the memory identifier 940, the stage generation circuitry 945, and/or the output generator 950. The example data storage 955 of the illustrated example of FIG. 9 can be implemented by any memory, storage device and/or storage disc for storing data such as flash memory, magnetic media, optical media, etc. Furthermore, the data stored in the example data storage 955 can be in any data format such as binary data, comma delimited data, tab delimited data, structured query language (SQL) structures, image data, etc.

While an example manner of implementing the mixed radix FFT calculator 804 of FIG. 8 is illustrated in FIG. 9, one or more of the elements, processes, and/or devices illustrated in FIG. 9 may be combined, divided, re-arranged, omitted, eliminated, and/or implemented in any other way. Further, the example data receiver 910, the example data length evaluator 915, the example mixed radix generator circuitry 920, the example bit/digit reverser 925, the example lookup table generation circuitry 930, the example threshold identifier 935, the example memory identifier 940, the example stage generation circuitry 945, the example output generator 950, and/or, more generally, the example mixed radix FFT calculator 804 of FIG. 8, may be implemented by hardware, software, firmware, and/or any combination of hardware, software, and/or firmware. Thus, for example, any of the example data receiver 910, the example data length evaluator 915, the example mixed radix generator circuitry 920, the example bit/digit reverser 925, the example lookup table generation circuitry 930, the example threshold identifier 935, the example memory identifier 940, the example stage generation circuitry 945, the example output generator 950, and/or, more generally, the example mixed radix FFT calculator 804, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example data receiver 910, the example data length evaluator 915, the example mixed radix generator circuitry 920, the example bit/digit reverser 925, the example lookup table generation circuitry 930, the example threshold identifier 935, the example memory identifier 940, the example stage generation circuitry 945, the example output generator 950, and/or, more generally, the example mixed radix FFT calculator 804 is/are hereby expressly defined to include a non-transitory computer readable storage device or storage disk such as a memory, a digital versatile disk (DVD), a compact disk (CD), a Blu-ray disk, etc., including the software and/or firmware. Further still, the example mixed radix FFT calculator 804 of FIG. 9 may include one or more elements, processes, and/or devices in addition to, or instead of, those illustrated in FIG. 9, and/or may include more than one of any or all of the illustrated elements, processes and devices.

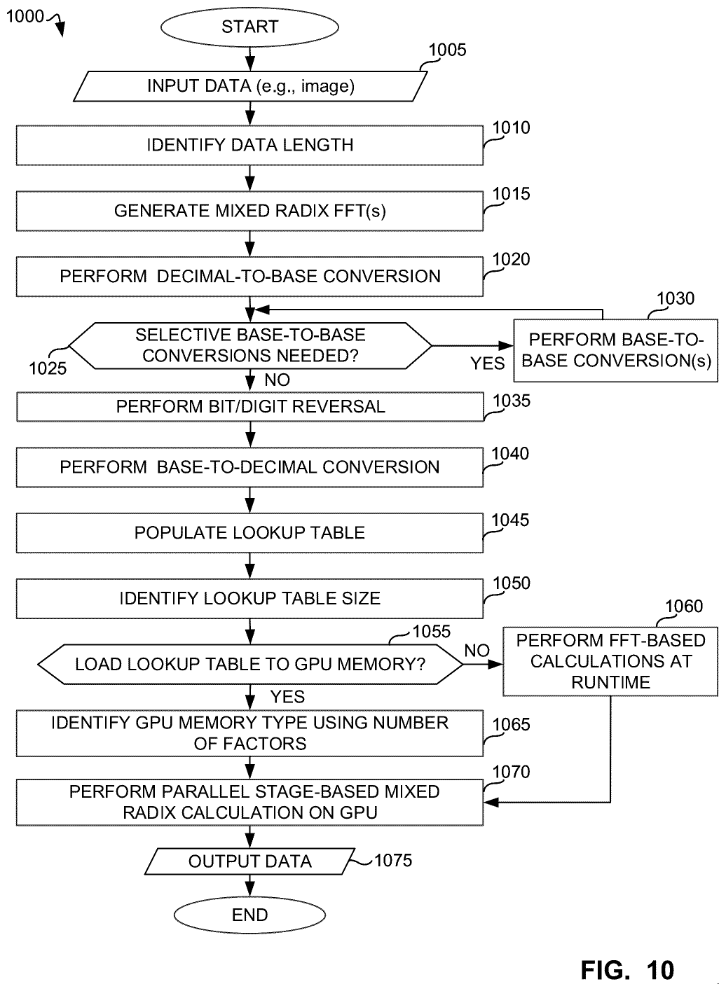

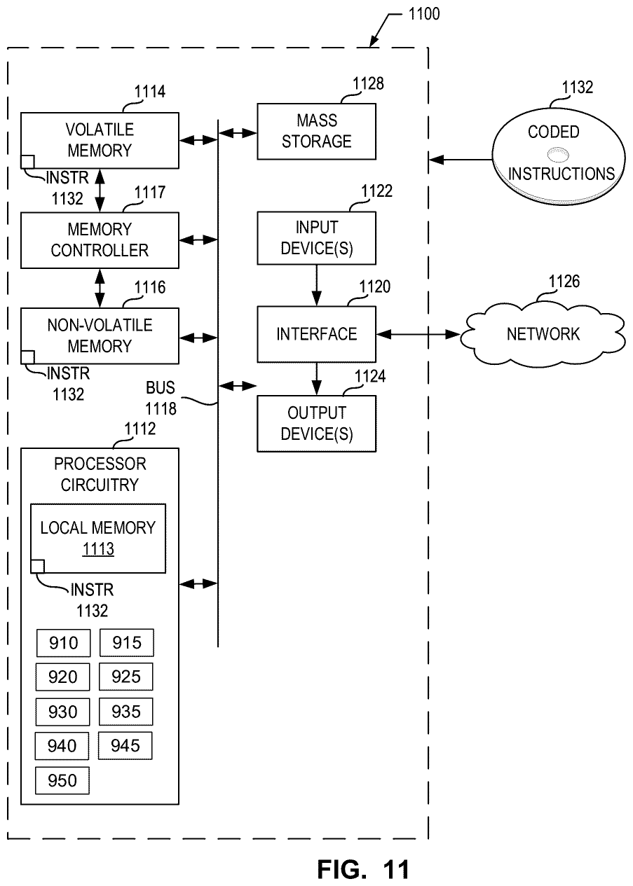

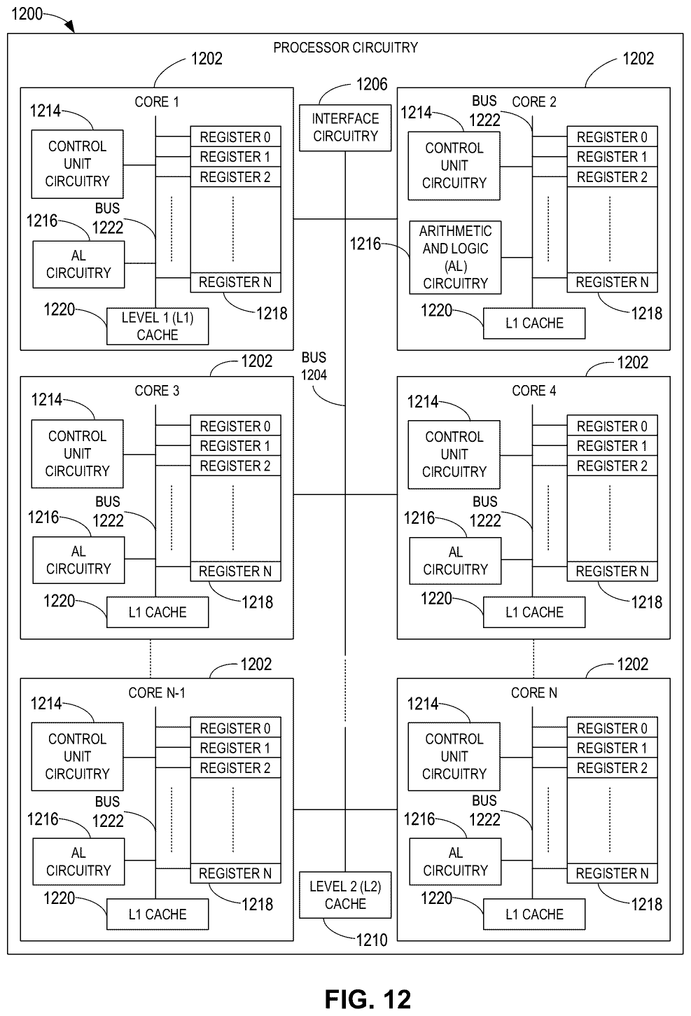

A flowchart representative of example hardware logic circuitry, machine readable instructions, hardware implemented state machines, and/or any combination thereof for implementing the mixed radix FFT calculator 804 of FIG. 8 is shown in FIG. 10. The machine readable instructions may be one or more executable programs or portion(s) of an executable program for execution by processor circuitry, such as the processor circuitry 1100 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 10, many other methods of implementing the example mixed radix FFT calculator 804 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B. (5) A with C. (6) B with C. or (7) A with B and with C. As used herein in the context of describing structures, components, items, objects and/or things, the phrase “at least one of A and B” is intended to refer to implementations including any of (1) at least one A. (2) at least one B, or (3) at least one A and at least one B. Similarly, as used herein in the context of describing structures, components, items, objects and/or things, the phrase “at least one of A or B” is intended to refer to implementations including any of (1) at least one A. (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A. (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 10 is a flowchart representative of example machine readable instructions and/or example operations 1000 that may be executed and/or instantiated by processor circuitry to implement the mixed radix FFT calculator 804 of FIG. 8. In the example of FIG. 10, the data receiver 910 receives input data (e.g., an image) (block 1005). For example, the input data can include input data with an arbitrary data length (e.g., data 802 of FIG. 8). The data length evaluator 915 identifies a data length associated with the input data received by the data receiver 910 (block 1010). For example, a data length of N=105 can be used to identify how the data can be factorized (e.g., using 7×5×3=105) as part of a determination of the number and/or type of mixed radix blocks to use for FFT based calculations (e.g., radix-7 blocks, radix-5 blocks, and/or radix-3 blocks). The mixed radix generator circuitry 920 generates the radix blocks as part of the mixed radix-based FFT calculations (block 1015). In some examples, the number of radix blocks (e.g., radix-7, radix-5, radix-3) can depend on the factorization of the initial data input, as shown in the example of FIG. 1. The mixed radix generator circuitry 920 can generate mixed radix blocks to allow for parallel-based calculation of the mixed radix FFTs on a GPU (e.g., GPU 824 of FIG. 8). In some examples, the mixed radix generator circuitry 920 performs decimal-to-base conversions of the initial input data (e.g., input data 802 of FIG. 8) as part of the mixed radix calculation process (block 1020). For example, the original data set can be in the form of index values and/or decimals (e.g., decimals 302, 352 of FIGS. 3A, 3B). The mixed radix generator circuitry 920 can convert the input decimals (e.g., decimals 302, 352) to a base representation (e.g., base-2, base-3, etc.), as shown in the examples of FIGS. 3A, 3B. In some examples, the mixed radix generator circuitry 920 identifies whether selective base-to-base conversions are needed (block 1025). For example, base-to-base conversions can be used to process one or more low bit(s) differently from the one or more high bit(s) of a given data set. In some examples, the low bit(s) of a given data set can undergo base-to-base conversion (e.g., from base-6 to base-2, etc.), as described in connection with FIG. 3B. If selective base-to-base conversion is needed, the mixed radix generator circuitry 920 performs the base-to-base conversion based on the factorization and/or radix-r blocks generated using the provided data length (block 1030). If the mixed radix generator circuitry 920 determines that selective base-to-base conversion is not needed (block 1025), control passes to the bit/digit reverser 925 to perform bit-digit reverse routine(s) (block 1035). The bit/digit reverser 925 performs bit/digit reversal to reverse a given set of bits and/or digits (e.g., from base-3 bits 304 to base-7 bits 308 of FIG. 3A). Once bit/digit reverse routine(s) are completed, the mixed radix generator circuitry 920 performs base-to-decimal conversion(s) on the remaining data (block 1040). In some examples, the mixed radix generator circuitry 920 converts high bit(s) using a first base (e.g., base-21) and/or low bit(s) using a second base (e.g., base-7) to yield the final output decimal values (e.g., decimals 364), as described in connection with FIG. 3B.

Once base-to-decimal conversions are completed, control proceeds from the mixed radix generator circuitry 920 to the lookup table generation circuitry 930 to generate and/or populate a lookup table with the final output decimal values (block 1045). The lookup table generation circuitry 930 generates a lookup table indicating the final output decimal values for a given initial data length (e.g., lookup table 380 of FIG. 3C). Once the table is populated with the final output decimal values, the lookup table generation circuitry 930 identifies the lookup table size (block 1050). For example, the lookup table size can govern the type of GPU memory (e.g., registers, etc.) that is optimal for lookup table storage. In some examples, a threshold identifier 935 identifies a threshold to set for the lookup table length (e.g., a maximum length of 2¹⁹) to switch between direct calculation of bit/digit reverse at runtime and storage in a designated GPU memory structure. For example, the memory identifier 940 identifies the available GPU memories where the lookup table can be stored. In some examples, the memory identifier 940 can be used to load the lookup table to a specified GPU memory structure based on lookup table length (block 1055). In some examples, when the lookup table length is less than 1024, the memory identifier 940 stores the table in registers (e.g., as an unsigned short type). In some examples, when the lookup table generation circuitry 930 determines that the lookup table length is greater than 1024 (2K bytes) but less than 32768 (64K bytes), the memory identifier 940 stores the table in shared local memory (e.g., as an unsigned short type). Likewise, when the lookup table length is greater than 32768, the memory identifier 940 stores the table in DRAM (e.g., as an unsigned int type). As the lookup table length increases, lookup table read operations become slower. As such, the lookup table generation circuitry 930 can use the threshold table length (e.g., a maximum length of 2¹⁹) to initiate direct calculation of bit/digit reverse at runtime (block 1060). If the table length requires calculations to be performed at runtime, the stage generation circuitry 945 proceeds with parallel stage-based mixed radix calculations on the GPU (block 1070). Otherwise, control proceeds to the memory identifier 940 to identify the GPU memory type where the lookup table can be stored (block 1065). In some examples, the memory identifier 940 uses the number of factors derived from the total data length to determine the optimal GPU memory storage structure, as shown in the example of FIG. 4. Once the lookup table is stored in the GLU memory, the stage generation circuitry 945 proceeds with the mixed radix FFT calculations performed in parallel to optimize system performance (block 1070). The output generator 950 generates the final output resulting from the performed mixed radix FFT calculations (e.g., mixed radix FFT output 842 of FIG. 8) (block 1075).

FIG. 11 is a block diagram of an example processor platform 1100 structured to execute and/or instantiate the machine readable instructions and/or operations of FIG. 10 to implement the mixed radix FFT calculator 804 of FIG. 8. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the data receiver 910, the data length evaluator 915, the mixed radix generator circuitry 920, the bit/digit reverser 925, the lookup table generation circuitry 930, the threshold identifier 935, the memory identifier 940, the stage generation circuitry 945, and/or the output generator 950.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 416 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output devices 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1132, which may be implemented by the machine readable instructions of FIG. 10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIG. 10.

The cores 1202 may communicate by an example bus 1204. In some examples, the bus 1204 may implement a communication bus to effectuate communication associated with one(s) of the cores 1202. For example, the bus 1204 may implement at least one of an Inter-Integrated Circuit (I2C) bus, a Serial Peripheral Interface (SPI) bus, a PCI bus, or a PCIe bus. Additionally or alternatively, the bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and an example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The bus 1220 may implement at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

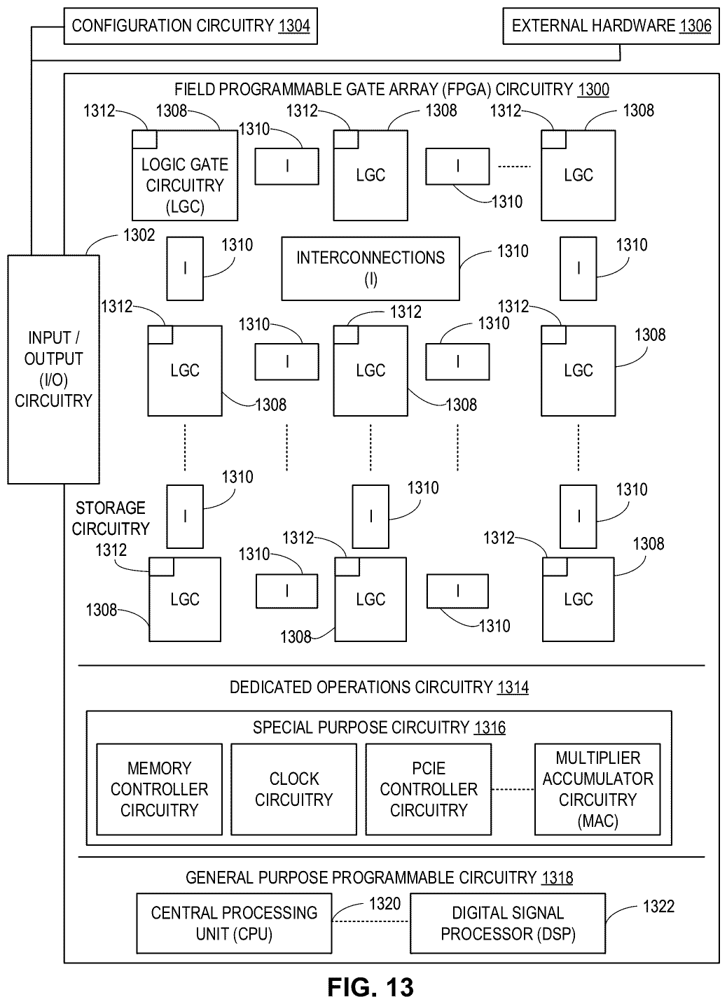

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowchart of FIG. 10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowchart of FIG. 10. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowchart of FIG. 10. As such, the FPGA circuitry 1300 may be structured to effectively instantiate some or all of the machine readable instructions of the flowchart of FIG. 10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIG. 10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIG. 10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 6 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowchart of FIG. 10 may be executed by one or more of the cores 1202 of FIG. 12 and a second portion of the machine readable instructions represented by the flowchart of FIG. 5 may be executed by the FPGA circuitry 1300 of FIG. 13.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

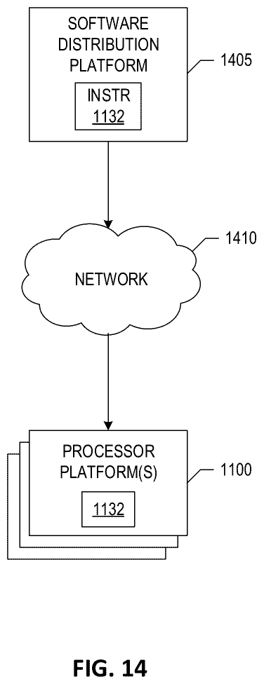

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 1000 of FIG. 10, as described above. The one or more servers of the example software distribution platform 1405 are in communication with a network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 1000 of FIG. 10, may be downloaded to the example processor platform 1100, which is to execute the machine readable instructions 1132 to implement the mixed radix FFT calculator 804. In some example, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that implement mixed radix FFT calculations on graphics processing units (GPUs). The disclosed systems, methods, apparatus, and articles of manufacture improve the efficiency of using a computing device by implementing a parallel method of general mixed radix FFTs for calculating FFTs of real and/or complex data sets of any length. In examples disclosed herein, multiple points can be computed in parallel on the GPUs instead of computing mixed radix FFTs point-by-point on the CPU. Additionally, methods and apparatus disclosed herein introduce calculation patterns based on FFT length for bit-reversed orders (e.g., used for radix-2 FFT algorithms). As such, methods and apparatus disclosed herein significantly improve processing performance by using multiple execution units (EUs) and/or single instruction, multiple data (SIMD) features available on graphics processing units (GPUs).

Example methods and apparatus to perform mixed radix fast Fourier transform (FFT) calculations on graphics processing units (GPUs) are disclosed herein. Further examples and combinations thereof include the following:

Example 1 includes an apparatus for parallel mixed radix calculation, the apparatus comprising at least one memory, machine readable instructions in the apparatus, and at least one processor circuitry to execute the machine readable instructions to at least factorize input data to identify one or more radix-r blocks for the parallel mixed radix calculation, perform at least one of a decimal-to-base or a base-to-base conversion of the input data prior to a bit reverse routine, the bit reverse routine to yield an output data set, cause a lookup table to be loaded into a memory structure based on a lookup table length, the lookup table populated with the output data set, and perform the parallel mixed radix calculation of the one or more radix-r blocks using the lookup table loaded into the memory structure.

Example 2 includes the apparatus of example 1, wherein the memory structure includes a register, a shared local memory, or a dynamic random access memory (DRAM) of a graphics processing unit (GPU).

Example 3 includes the apparatus of example 2, wherein the lookup table of a first length is loaded into the register, the lookup table of a second length is loaded into the shared local memory, and the lookup table of a third length is loaded into the DRAM, the third length greater than at least one of the first length or the second length.

Example 4 includes the apparatus of example 3, wherein the processor circuitry is to determine a lookup table length threshold, the lookup length threshold including a fourth lookup table length greater than the third length.

Example 5 includes the apparatus of example 4, wherein, when the lookup table length reaches the lookup table length threshold, the instructions are to perform the parallel mixed radix calculation during runtime without loading the lookup table into the memory structure.

Example 6 includes the apparatus of example 1, wherein the processor circuitry is to perform parallel mixed radix calculation by performing parallel calculation of the radix-r blocks using at least one of a graphic processing unit (GPU) execution unit or a single instruction, multiple data (SIMD) core.

Example 7 includes the apparatus of example 1, wherein the processor circuitry is to perform base-to-base conversion by converting a high bit from a first base to a second base, the first base different from the second base.

Example 8 includes the apparatus of example 1, wherein the processor circuitry is to perform base-to-base conversion by converting a low bit to a first base and a high bit to a second base, the first base different from the second base.

Example 9 includes the apparatus of example 1, wherein the processor circuitry is to perform a first set of radix-r block calculations in a first stage of the parallel mixed radix calculation and to perform a second set of radix-r block calculations in a second stage of the parallel mixed radix calculation.

Example 10 includes a method for parallel mixed radix calculation, the method comprising factorizing input data to identify one or more radix-r blocks for the parallel mixed radix calculation, performing at least one of a decimal-to-base or a base-to-base conversion of the input data prior to a bit reverse routine, the bit reverse routine to yield an output data set, loading a lookup table into a memory structure based on a lookup table length, the lookup table populated with the output data set, and performing the parallel mixed radix calculation of the one or more radix-r blocks using the lookup table loaded into the memory structure.

Example 11 includes the method of example 10, wherein the memory structure includes a register, a shared local memory, or a dynamic random access memory (DRAM) of a graphics processing unit (GPU), and further including loading the lookup table of a first length into the register, loading the lookup table of a second length into the shared local memory, and loading the lookup table of a third length into the DRAM, the third length greater than at least one of the first length or the second length.

Example 12 includes the method of example 11, further including determining a lookup table length threshold, the lookup length threshold including a fourth lookup table length greater than the third length.

Example 13 includes the method of example 12, wherein, when the lookup table length reaches the lookup table length threshold, the performing of the parallel mixed radix calculation occurs during runtime without loading the lookup table into the memory structure.

Example 14 includes the method of example 10, wherein the performing of the parallel mixed radix calculation includes performing parallel calculations of the radix-r blocks using at least one of a graphic processing unit (GPU) execution unit or a single instruction, multiple data (SIMD) core.

Example 15 includes the method of example 10, wherein the performing of the base-to-base conversion includes converting a high bit from a first base to a second base, the first base different from the second base.

Example 16 includes the method of example 10, wherein the performing of the base-to-base conversion includes converting a low bit to a first base and a high bit to a second base, the first base different from the second base.

Example 17 includes the method of example 10, further including performing a first set of radix-r block calculations in a first stage of the parallel mixed radix calculation and performing a second set of radix-r block calculations in a second stage of the parallel mixed radix calculation.

Example 18 includes a non-transitory computer readable storage medium comprising instructions that, when executed, cause processor circuitry to at least factorize input data to identify one or more radix-r blocks for the parallel mixed radix calculation, perform at least one of a decimal-to-base or a base-to-base conversion of the input data prior to a bit reverse routine, the bit reverse routine to yield an output data set, cause a lookup table to be loaded into a memory structure based on a lookup table length, the lookup table populated with the output data set, and perform the parallel mixed radix calculation of the one or more radix-r blocks using the lookup table loaded into the memory structure.

Example 19 includes the non-transitory computer readable storage medium of example 18, wherein the memory structure includes a register, a shared local memory, or a dynamic random access memory (DRAM) of a graphics processing unit (GPU), and the instructions, when executed, cause the processor to load the lookup table of a first length into the register, load the lookup table of a second length into the shared local memory, and load the lookup table of a third length into the DRAM, the third length greater than at least one of the first length or the second length.

Example 20 includes the non-transitory computer readable storage medium of example 19, wherein the instructions, when executed, cause the processor circuitry to determine a lookup table length threshold, the lookup length threshold including a fourth lookup table length greater than the third length.

Example 21 includes the non-transitory computer readable storage medium of example 20, wherein the instructions, when executed, cause the processor circuitry to perform the parallel mixed radix calculation during runtime without loading the lookup table into the memory structure when the lookup table length reaches the lookup table length threshold.

Example 22 includes the non-transitory computer readable storage medium of example 18, wherein the parallel mixed radix calculation includes parallel calculations of the radix-r blocks using at least one of a graphic processing unit (GPU) execution unit or a single instruction, multiple data (SIMD) core.

Example 23 includes the non-transitory computer readable storage medium of example 18, wherein the base-to-base conversion includes converting a high bit from a first base to a second base, the first base different from the second base.

Example 24 includes the non-transitory computer readable storage medium of example 18, wherein the base-to-base conversion includes converting a low bit to a first base and a high bit to a second base, the first base different from the second base.

Example 25 includes the non-transitory computer readable storage medium of example 18, wherein the instructions, when executed, cause the processor circuitry to perform a first set of radix-r block calculations in a first stage of the parallel mixed radix calculation and a second set of radix-r block calculations in a second stage of the parallel mixed radix calculation.

Example 26 includes an apparatus for parallel mixed radix calculation, the apparatus comprising interface circuitry to obtain input data, and processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations or the third operations to instantiate mixed radix generation circuitry to factorize input data to identify one or more radix-r blocks for the parallel mixed radix calculation, and perform at least one of a decimal-to-base or a base-to-base conversion of the input data prior to a bit reverse routine, the bit reverse routine to yield an output data set, lookup table generation circuitry to load a lookup table into a memory structure based on a lookup table length, the lookup table populated with the output data set, and stage generation circuitry to perform the parallel mixed radix calculation of the one or more radix-r blocks using the lookup table loaded into the memory structure.

Example 27 includes the apparatus of example 26, wherein the memory structure includes a register, a shared local memory, or a dynamic random access memory (DRAM) of the graphics processing unit (GPU).

Example 28 includes the apparatus of example 27, wherein the processor circuitry is to cause the lookup table of a first length to be loaded into the register, the lookup table of a second length to be loaded into the shared local memory, and the lookup table of a third length to be loaded into the DRAM, the third length greater than at least one of the first length or the second length.

Example 29 includes the apparatus of example 28, wherein the processor circuitry is to determine a lookup table length threshold, the lookup length threshold including a fourth lookup table length greater than the third length.

Example 30 includes the apparatus of example 29, wherein, when the lookup table length reaches the lookup table length threshold, the stage generation circuitry is to perform the parallel mixed radix calculation during runtime without the circuitry loading of the lookup table into the memory structure.

Example 31 includes the apparatus of example 26, wherein the mixed radix generator circuitry is to perform the parallel mixed radix calculation by parallel calculation of the radix-r blocks using at least one of the graphic processing unit (GPU) or a single instruction, multiple data (SIMD) core.

Example 32 includes the apparatus of example 26, wherein the mixed radix generator circuitry is to perform the base-to-base conversion by converting a high bit from a first base to a second base, the first base different from the second base.

Example 33 includes the apparatus of example 26, wherein the mixed radix generator circuitry is to perform the base-to-base conversion by converting a low bit to a first base and a high bit to a second base, the first base different from the second base.

Example 34 includes the apparatus of example 26, wherein the stage generation circuitry performs a first set of radix-r block calculations in a first stage of the parallel mixed radix calculation and a second set of radix-r block calculations in a second stage of the parallel mixed radix calculation.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus for parallel mixed radix calculation, the apparatus comprising:
memory;
machine readable instructions; and
processor circuitry to execute the machine readable instructions to at least:
factorize input data to identify one or more radix-r blocks for the parallel mixed radix calculation;
perform at least one of a decimal-to-base or a base-to-base conversion of the input data prior to a bit reverse routine, the bit reverse routine to yield an output data set;
cause a lookup table to be loaded into a memory structure based on a lookup table length, the lookup table populated with the output data set; and
perform the parallel mixed radix calculation of the one or more radix-r blocks using the lookup table loaded into the memory structure.

2. The apparatus of claim 1, wherein the memory structure includes a register, a shared local memory, or a dynamic random access memory (DRAM) of a graphics processing unit (GPU).

3. The apparatus of claim 2, wherein the lookup table of a first length is loaded into the register, the lookup table of a second length is loaded into the shared local memory, and the lookup table of a third length is loaded into the DRAM, the third length greater than at least one of the first length or the second length.

4. The apparatus of claim 3, wherein the processor circuitry is to determine a lookup table length threshold, the lookup length threshold including a fourth lookup table length greater than the third length.

5. The apparatus of claim 4, wherein, when the lookup table length reaches the lookup table length threshold, the instructions are to perform the parallel mixed radix calculation during runtime without loading the lookup table into the memory structure.

6. The apparatus of claim 1, wherein the processor circuitry is to perform parallel mixed radix calculation by performing parallel calculation of the radix-r blocks using at least one of a graphic processing unit (GPU) execution unit or a single instruction, multiple data (SIMD) core.

7. The apparatus of claim 1, wherein the processor circuitry is to perform base-to-base conversion by converting a high bit from a first base to a second base, the first base different from the second base.

8. (canceled)

9. (canceled)

10. A method for parallel mixed radix calculation, the method comprising:
factorizing input data to identify one or more radix-r blocks for the parallel mixed radix calculation;
performing at least one of a decimal-to-base or a base-to-base conversion of the input data prior to a bit reverse routine, the bit reverse routine to yield an output data set;
loading a lookup table into a memory structure based on a lookup table length, the lookup table populated with the output data set; and
performing the parallel mixed radix calculation of the one or more radix-r blocks using the lookup table loaded into the memory structure.

11. The method of claim 10, wherein the memory structure includes a register, a shared local memory, or a dynamic random access memory (DRAM) of a graphics processing unit (GPU), and further including loading the lookup table of a first length into the register, loading the lookup table of a second length into the shared local memory, and loading the lookup table of a third length into the DRAM, the third length greater than at least one of the first length or the second length.

12. The method of claim 11, further including determining a lookup table length threshold, the lookup length threshold including a fourth lookup table length greater than the third length.

13. The method of claim 12, wherein, when the lookup table length reaches the lookup table length threshold, the performing of the parallel mixed radix calculation occurs during runtime without loading the lookup table into the memory structure.

14. The method of claim 10, wherein the performing of the parallel mixed radix calculation includes performing parallel calculations of the radix-r blocks using at least one of a graphic processing unit (GPU) execution unit or a single instruction, multiple data (SIMD) core.

15. The method of claim 10, wherein the performing of the base-to-base conversion includes converting a high bit from a first base to a second base, the first base different from the second base.

16. The method of claim 10, wherein the performing of the base-to-base conversion includes converting a low bit to a first base and a high bit to a second base, the first base different from the second base.

17. (canceled)

18. A non-transitory computer readable storage medium comprising instructions to cause processor circuitry to at least:
factorize input data to identify one or more radix-r blocks for the parallel mixed radix calculation;
perform at least one of a decimal-to-base or a base-to-base conversion of the input data prior to a bit reverse routine, the bit reverse routine to yield an output data set;
cause a lookup table to be loaded into a memory structure based on a lookup table length, the lookup table populated with the output data set; and
perform the parallel mixed radix calculation of the one or more radix-r blocks using the lookup table loaded into the memory structure.

19. The non-transitory computer readable storage medium of claim 18, wherein the memory structure includes a register, a shared local memory, or a dynamic random access memory (DRAM) of a graphics processing unit (GPU), and the instructions are to cause the processor to load the lookup table of a first length into the register, load the lookup table of a second length into the shared local memory, and load the lookup table of a third length into the DRAM, the third length greater than at least one of the first length or the second length.

20. The non-transitory computer readable storage medium of claim 19, wherein the instructions are to cause the processor circuitry to determine a lookup table length threshold, the lookup length threshold including a fourth lookup table length greater than the third length.

21. The non-transitory computer readable storage medium of claim 20, wherein the instructions are to the processor circuitry to perform the parallel mixed radix calculation during runtime without loading the lookup table into the memory structure when the lookup table length reaches the lookup table length threshold.

22. The non-transitory computer readable storage medium of claim 18, wherein the parallel mixed radix calculation includes parallel calculations of the radix-r blocks using at least one of a graphic processing unit (GPU) execution unit or a single instruction, multiple data (SIMD) core.

23. The non-transitory computer readable storage medium of claim 18, wherein the base-to-base conversion includes converting a high bit from a first base to a second base, the first base different from the second base.

24-34. (canceled)
